(19) United States
(12) Patent Application Publication
(10) Pub. No.: US 2007/0084116 A1
(43) Pub. Date: Apr. 19, 2007

(54) Reformer system having electrical heating devices

(75) Inventors: Juergen Ringler, Kissing (DE); Christian Liebl, Eching (DE); Michael Preis, Koenigsbrunn (DE); Jochem Huber, Muenchen (DE); John Kirwan, Shelby Township, MI (US); Malcolm James Grieve, Henrietta, NY (US)

Correspondence Address: CROWELL & MORING LLP;INTELLECTUAL PROPERTY GROUP, P.O. BOX 14300, WASHINGTON, DC, 20044-4300, US

(73) Assignees: Bayerische Motoren Werke Aktiengesellschaft, Muenchen (DE); Delphi Technologies, Inc., Troy, MI (US)

(21) Appl. No.: 11/248,165

(22) Filed: Oct. 13, 2005

(51) Int. Cl. B01J 8/00

(52) U.S. Cl. 48/127.9

(57) ABSTRACT

A vehicle reforming system includes a reformer for chemically converting a hydrocarbon-containing fuel to a hydrogen-gas-rich reformate gas, as well as electric heating devices by which thermal energy for generating a reaction temperature required for the conversion may be fed to the reformer. The reformer system also has a high-performance capacitor, which supplies the electric heating devices with electric current.

### CROSS-REFERENCE TO RELATED APPLICATION

This application is related to co-pending U.S. patent application Ser. No. ______, entitled “Reformer System and Method Reforming”.

### BACKGROUND AND SUMMARY OF THE INVENTION

The invention relates to a reformer system having a reformer for the chemical conversion of a hydrocarbon-containing fuel to a hydrogen-gas-rich reformate gas, as well as to electric heating devices by which thermal energy for generating a reaction temperature required for the conversion may be fed to the reformer system. The invention also relates to a vehicle having such a reformer system.

Reformers are generally used in motor vehicles for generating a hydrogen-rich synthesis or reformate gas consisting of hydrogen (H₂), carbon monoxide (CO) and inert gas (N₂, CO₂, H₂O) from liquid or gaseous hydrocarbon-containing fuels. Liquid fuels, such as gasoline, diesel, or alcohols, and gaseous fuels, such as methane or natural gas, can be used as the fuels. For converting the fuel to the hydrogen-rich reformate gas, different reforming methods are known, among them, partial oxidation, steam reforming, CO₂ reforming, cracking or combinations thereof, such as autothermal reforming. While the partial oxidation takes place extremely exothermally, all other processes are endothermal or approximately energy-neutral. For increasing the hydrogen yield, a so-called shift reaction (water gas equilibrium) may follow. The reformate gas generated by the reformer may be used in motor vehicles for the operation of a fuel cell. Furthermore, such a reformate gas may be fed to an internal-combustion engine for minimizing the cold-start, warming-up and engine-out emissions. In addition, reformate gas is used for the aftertreatment of the exhaust gases of an internal-combustion engine.

As a rule, the reforming processes in the reformer take place at very high temperatures; that is, at temperatures starting at least at 800° C. For the initiation of the reaction and a subsequent stable progression of the reaction, suitable areas of the reformer, therefore, have to be brought to this temperature level by feeding thermal energy. In order to successfully start the reforming process, according to U.S. Pat. No. 6,728,602, a catalyst is heated in the reformer system by using an electric heating element. In this case, the heating element is supplied with electric current from a vehicle battery.

In the case of another process known from the state of the art, such as U.S. Patent Publication 2002/010831 A1, the reformer is thermally preheated by use of a combustion process connected in front. However, undesirable emissions, such as HC as well as NOₓ emissions, occur during such a thermal preheating of the reformer.

The energy demand of heating devices for permitting a fast reformer start is considerable. Since the power applied by a conventional vehicle battery is limited, however, a comparatively long time period is necessary for the corresponding heating of the reformer. For shortening the starting time of the reforming process, a considerably larger vehicle battery or an additional booster battery has to be carried along, which leads to considerable costs and also results in weight and space problems in the vehicle. However, a slow starting time results in higher emissions since higher HC and NOₓ emissions occur during a combustion start at typical ambient temperatures than under hot running conditions. In the case of liquid fuels, the emission behavior additionally deteriorates during the combustion start since, at a correspondingly low temperature, the homogenization process between the liquid medium and air becomes difficult. Furthermore, a temperature outside the operating window of the catalyst may lead to a limitation of desirable reaction processes and/or an intensified occurrence of undesirable secondary reactions. This also has the tendency to cause higher pollutant emissions.

There is therefore needed a reformer system especially for a motor vehicle, that permits a fast reformer start at acceptable costs while reducing the resulting undesired emissions.

According to the invention, these needs, as well as others, are met by a reformer system of the above mentioned type, which also has a capacitor supplying the electric heating devices with electric current. Furthermore, the needs are met by providing a vehicle which has such a reformer system according to the invention.

The solution according to the invention is based on the recognition that the electric heating devices for heating the reformer to a temperature required for starting the reformation process have to be supplied with current only for a short time period. As soon as the reaction temperature has been reached, a self-sustaining process takes place in the reformer, which may be maintained by feeding only minimal additional thermal energy (or none at all) from the outside. This means that while the total electric energy required for starting the reformation process is limited, it must be possible to provide the electric energy rapidly. The use of a capacitor according to the present invention meets these requirements in a very cost-effective and space-saving manner, especially in contrast to conventional vehicle lead batteries. Specifically, this capacitor can store a certain electric charge quantity and supply it to the electric heating devices within a very short time. The charge storable in the capacitor is adapted to bring the reformer system to the reaction temperature required for starting the reformation process. Subsequently, the capacitor is immediately charged again, for example, by means of the vehicle battery or a fuel cell, for a future starting operation. In the case of these high-performance capacitors, this process can take place within a very short time.

As an advantageous embodiment of the invention, the capacitor is designed as a high-performance capacitor. By using such a high-performance capacitor (or an ultracap or supercap), the electric heating devices may be supplied with the electric energy required for heating the reformer system within a particularly short time, whereby the starting time of the reformer system may be further improved.

The reformer system, expediently, has a chemical reaction accelerator for reducing the reaction temperature required for the conversion. Furthermore, this reaction accelerator may advantageously be heated by use of the electric heating devices at least in a heating section. As a result of the chemical reaction accelerator, a considerable reduction of the reaction temperature can be achieved. For gasoline or diesel fuels, this reaction temperature is reduced from approximately 1,500° C. to approximately 800° C. to 1,000° C. In order to bring the reaction accelerator, as fast as possible, to its starting temperature above which it can develop its reaction-accelerating effect, it is advantageous to heat the reaction accelerator by using the electric heating devices at least in a heating section. The heating energy may be utilized particularly efficiently when the front surface of the reaction accelerator, on which the hydrocarbon-containing fuel/air mixture is entering, can be heated. Furthermore, it is useful when, in the case of a reaction accelerator, whose longitudinal direction is arranged parallel to the flow direction of the reformate gas, a certain partial section in the longitudinal direction of the reaction accelerator can be heated. In this case, the electrically heatable area of the reaction accelerator does not necessarily have to be situated at the inlet of the reaction accelerator, but rather may also start inside the reaction accelerator.

The heating effect may be achieved in a particularly cost- and space-saving manner in that the electric heating devices are integrally connected with the reaction accelerator. In particular, they may form a substrate of the reaction accelerator in the heating section. Thus, the reaction accelerator may, for example, have a metallic substrate which has an electric resistor suitable for heating the reaction accelerator. The reaction accelerator may also be exteriorly surrounded by corresponding heating devices having an electric resistor; in particular, it may be enveloped by these heating devices.

Outside the heating section, an electrically insulating material, particularly a ceramic material, may form a substrate of the reaction accelerator. In the case of such a non-conductive substrate, the heating section of the reaction accelerator may be distinctly defined, and the heating effect of the electric current may thereby be optimized in the defined heating section. In other words, in a defined heating zone with a given electric heating energy, a temperature can thereby be obtained which is as high as possible. As soon as the starting temperature of the accelerator has been reached or exceeded in this heating zone, the reformation process is started. As a rule, in the further course, sufficient heat is generated by the chemical conversion in order to correspondingly heat up areas of the reaction accelerator which are still below the starting temperature. The section of the reaction accelerator formed of an electrically insulating substrate may either be in direct contact with the heating section or may be spaced away from it. In the case of a spaced arrangement, the heating section is, for the most part, thermally insulated, whereby the thermal energy charged by the electric heating devices optimally heats the heating section.

In addition, in order to permit an optimal starting time of the reformation process, it is advantageous for the reformer system to have a processing zone for processing the hydrocarbon-containing fuel before the chemical conversion, and for the processing zone to be heatable by use of the electric heating devices. The processing zone has the purpose of evaporating the hydrocarbon-containing fuel before the actual reformation reaction and to homogenize it with the air such that the reformation reaction may take place in an optimal manner. The heating-up of the processing zone taking place according to the invention includes, particularly, also a direct heating-up of the fuel/air mixture contained in the processing zone. Because the heating-up already takes place in the processing zone, in addition to a faster starting time of the reformation process, a more complete conversion of the fuel to reformate gas is also caused. This, in turn, reduces the undesirable emissions occurring during the reformation process.

Advantageously, the processing zone is constructed as a mixture forming zone, in which the hydrocarbon-containing fuel is mixed with air, and/or as a fuel vaporization zone, in which the hydrocarbon-containing fuel is vaporized. The fuel is advantageously injected by an injector into the processing zone, whereby it is finely distributed in the processing zone. A homogeneous air/fuel mixture is thereby formed in the processing zone constructed as the mixture forming zone. As mentioned above, the processing zone may also be constructed as a fuel vaporization zone. In this evaporation zone, the thermal energy fed by the electric heating devices is used for the vaporization of the fuel. Vaporization of the fuel permits the generation of a particularly homogeneous air/fuel mixture. In addition, by heating the air supplied from the outside, a further homogenization of the mixture may be achieved. The presence of a largely homogeneous air/fuel mixture leads to a particularly complete conversion of the fuel in the subsequent reformation process, whereby residues and, particularly, undesirable emissions can be reduced to a minimum.

The electric heating devices may expediently include: a wire (in particular for heating up the processing zone and in the form of a wire grid construction), devices for generating electromagnetic radiation, and/or devices for generating an arc or a plasma. The wire grid construction may surround the entire processing zone or a partial section thereof. In this case, the wire grid construction preferably represents an enveloping of the processing zone in a longitudinal direction parallel to the flow direction of the reformate gas. In this case, the enveloping may also extend along only a portion of the length of the processing zone in the longitudinal direction. While a wire grid construction permits a particularly cost-effective implementation of the heating effect, by using devices for generating electromagnetic radiation and/or a device for generating an arc or a plasma, energy can be transmitted directly to the individual molecules of the air/fuel mixture situated in the processing zone. In this manner, a particularly efficient energy transmission and, thus, a particularly fast heating-up of the air/fuel mixture can take place. A microwave generator can, for example, be used as the device for generating electromagnetic radiation.

For improving the fuel vaporization and/or mixture formation process, the reformer system according to the invention advantageously has a heat exchanger zone, which is connected in a heat-conducting manner with a flow-off zone of the reformate gas and/or a reaction zone having the reaction accelerator, and by which outside air can be preheated and can then be caused to flow or be introduced into the processing zone. As a result, the waste heat of the reformate gas can be utilized for preheating the air used for the formation of the air/fuel mixture. The heating demand in the processing zone is thereby reduced or even completely eliminated as soon as the reformer system is in a stable reaction process after proceeding the starting phase.

In order to further shorten the starting phase of the reformer system, it is advantageous for the reformer system to have an electric ignition device arranged in the area of the processing zone, by which ignition device a fuel combustion or fuel oxidation may be generated for heating up the processing zone. The reaction temperature required for a stable reformation process can thereby be reached more rapidly.

In an advantageous embodiment, the hydrocarbon-containing fuel, which can be converted by the reformer system, is liquid and includes particularly gasoline, diesel, military fuels such as JP8 or the like, or other such fuels such as kerosene biodiesel, alcohol or oxygenated fuels and the like. The use of gasoline or diesel in reformer systems used in motor vehicles is particularly advantageous because these fuels can already be used in current engines, and therefore no adaptation measures become necessary at the fuel stations.

For minimizing the electric energy required in the reformation operation, it is advantageous for the reformer system to be designed for carrying out a partial oxidation process for converting the hydrocarbon-containing fuel to a hydrogen-rich reformate gas. Since the partial oxidation takes place extremely exothermally, no further thermal energy has to be fed from the outside after the reaction temperature has been reached in the reformer.

In order to supply the electric heating devices optimally with current, the reformer system advantageously has a temperature sensor for measuring a temperature in the processing zone and/or at the reaction accelerator, as well as a control device for controlling the current supply of the electric heating devices as a function of the measured temperature. As a result, the electric energy present in the capacitor may optimally and without unnecessary losses be used for starting the reformer system. The temperature gradient ΔT/Δt may in this case be used as the command variable of the control device. The determination of the temperature gradient may advantageously be carried out by measuring the change of the electric resistance of a grid wire or substrate used as the heating device. Furthermore, the temperature gradient may also be determined by temperature measurements by use of temperature sensors. The electric power supplied by the capacitor may thereby be supplied according to the demands since, although, on the one hand, the heating-up of the corresponding zones is to take place in the sense of a very fast reformer start which simultaneously is as emission-free as possible, on the other hand, an overheating of these zones is to be avoided for safety and durability reasons.

Advantageously, the reformer system has a control unit for controlling the power supply of the electric heating devices and to adapt the power supply to changing boundary conditions of the reformer system, such as aging effects, component tolerances, and/or fuel influences. Regulating the electric energy supplied by the capacitor can therefore take place such that the temperature course occurring in the corresponding zones corresponds to a desired definition. When the respective maximally permissible temperature is reached, the heating operation is interrupted. By using a heating strategy equipped in this manner, differences in the heating-up behavior of the zone as a result of varying fuel qualities (such as quantity variances of the fuel supply valve) may be compensated in order to thereby ensure a constantly reproducible fast reformer start with minimal emissions.

A vehicle according to the invention equipped with the above-mentioned reformer system advantageously has a consuming device, particularly an internal-combustion engine, an exhaust gas aftertreatment system of an internal-combustion engine, and/or a fuel cell, which is connected with gas feeding devices for feeding the reformate gas from the reformer system to the consuming device. A feeding of the reformate gas to the internal-combustion engine is used for minimizing the cold start/warm-up and engine-out emissions of the internal-combustion engine. In this case, it is particularly important that the reformation process may be started within a very short time and with the minimal pollutants because the emissions of the internal-combustion engine are the highest at its start. The same applies to the use of the reformate gas in an exhaust gas aftertreatment system.

Other objects, advantages and novel features of the present invention will become apparent from the following detailed description of the invention when considered in conjunction with the accompanying drawings.

### BRIEF DESCRIPTION OF THE DRAWINGS

In the following, embodiments of a reformer system according to the invention will be explained in detail by means of the attached schematic drawings.

FIG. 1 is a partial sectional view of a first embodiment of a reformer system according to the invention with a heatable mixture forming zone;

FIG. 2 is a partial sectional view of a second embodiment of a reformer system according to the invention with a heatable reaction accelerator;

FIG. 3 is a partial sectional view of a third embodiment of a reformer system having a heatable mixture forming zone as well as a heatable reaction accelerator;

FIG. 4 is a partial sectional view of an embodiment of a reformer which can be used in a reformer system according to the invention as an alternative to the reformers illustrated in FIGS. 1 to 3; and

FIG. 5 is a view of the mixture forming zone as well as of the reaction zone of a reformer system according to the invention.

### DETAILED DESCRIPTION OF THE DRAWINGS

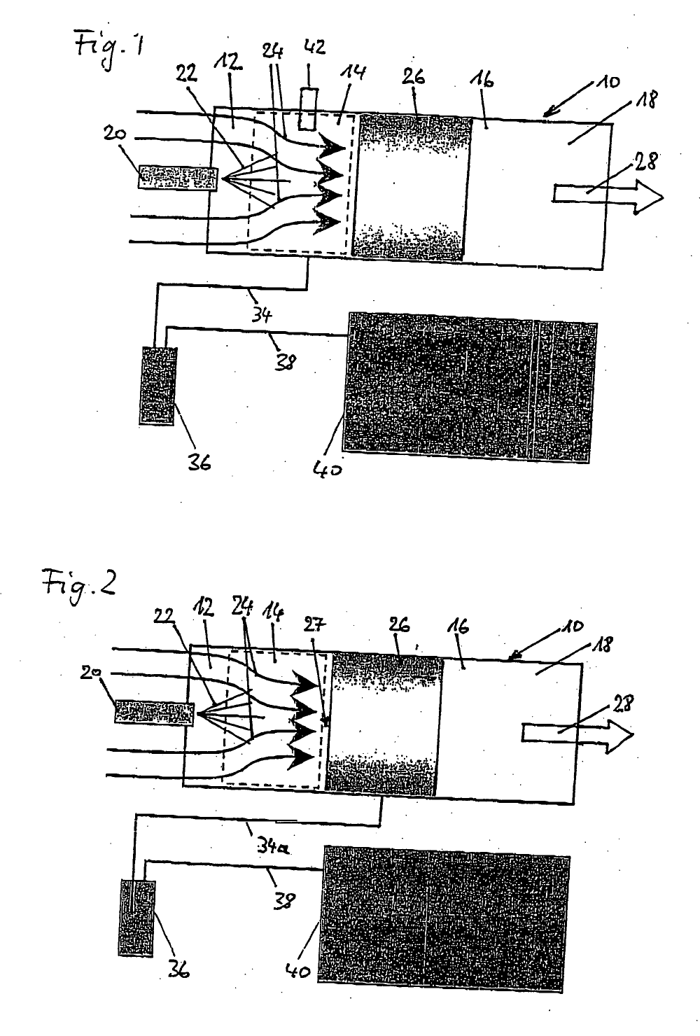

FIGS. 1 to 3 illustrate various embodiments of a reformer system according to the invention. These embodiments each include a reformer 10, which is constructed as an oblong receptacle. In the reformer 10, an in-flow zone 12, a mixture forming zone 14 (outlined by a broken boundary line), a reaction zone 16 and an out-flow zone 18 are arranged in the longitudinal direction. Air 24 taken in from the outside flows through the in-flow zone 12 into the mixture forming zone 14. In this case, the air is delivered into the reformer by way of a pump or a fan, which is not shown in the figures. An injector 20 injects fuel 22, such as gasoline or diesel, by way of the in-flow zone 12 into the mixture forming zone 14. The typical relative air/fuel ratio λ for a partial oxidation taking place in the reaction zone 16 is in the range of approximately 0.33.

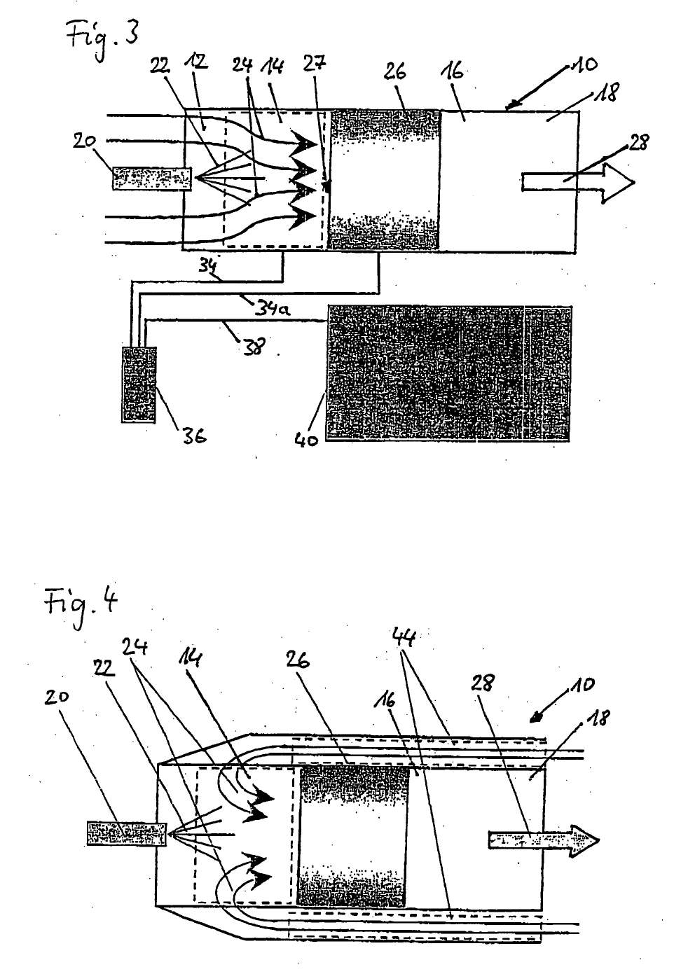

In the embodiment illustrated in FIG. 1, electric heating devices, such as a heating wire structure 30 illustrated in FIG. 5, are arranged in the mixture forming zone 14, by which thermal energy can be fed to the mixture forming zone 14. As an alternative, a microwave generator may also be used as the electric heating device 30. The heat feed, on the one hand, promotes the vaporization of the fuel 22 in the air 24 for aiding an optimal mixing of the air/fuel mixture. On the other hand, the air/fuel mixture is brought to a reaction temperature by the heat feed, at which reaction temperature the reformation process starts. The reformation process is assisted by a reaction accelerator 26 and takes place automatically. The heating of the air/fuel mixture can also be promoted by way of a precursory combustion process. The reaction temperature required for the implementation of the reformation process is at approximately 800° C. to 1,000° C. when gasoline or diesel is used as the fuel 22. As illustrated in FIG. 1, the mixture forming zone 14 optionally may also have an electric ignition device 42 to promote the heating-up of the air/fuel mixture. Such an electric ignition device 42 may also be provided for the embodiments of the reformer system according to the invention illustrated in FIGS. 2 and 3.

By way of an electric circuit 34, the electric heating devices 30 are connected with a high-performance capacitor 36. This capacitor 36 has a capacity sufficient for storing the charge required for heating the air/fuel mixture to the reaction temperature. The capacitor can discharge to the electric heating devices 30 within a very short time, which is why the time period required for starting the reformer system can be very brief. By way of another electric circuit 38, the high-performance capacitor 36 is connected with the vehicle battery 40 or a fuel cell carried along in the vehicle, such as an SOFC, for the recharging. The air/fuel mixture heated in this manner then enters into the reaction zone 16 containing the reaction accelerator 26, in which reaction zone 16 the air/fuel mixture is converted to a hydrogen-rich synthesis gas, which will be called a “reformate gas” 28 in the following.

In the reformer system embodiment according to the invention illustrated in FIG. 2, instead of the mixture forming zone 14, the reaction accelerator 26 is equipped with electric heating devices 32. The electric heating devices 32 are schematically illustrated in FIG. 5. In this case, particularly the face of the reaction accelerator 26 facing the air/fuel flow can be heated. The electric heating devices 32 may include heating wires, as in the embodiment illustrated in FIG. 1, but may also form a substrate of the reaction accelerator 26. By heating the reaction accelerator 26, the reaction accelerator is brought to the starting temperature at which it promotes the reformation process. Also in the present embodiment, the electric heating devices 32 are supplied with current by way of an electric circuit 34a by using a high-performance capacitor 36, which can be recharged by way of a vehicle battery 40.

In the reformer system embodiment illustrated in FIG. 3, the mixture forming zone 14 as well as the reaction accelerator 26 have electric heating devices 30 and 32 respectively, as illustrated in FIG. 5. These are each connected by way of one electric circuit 34 and 34a, respectively, with a high-performance capacitor 36, which can be recharged by way of a vehicle battery 40.

FIG. 5 illustrates the respective dimensions of the electric heating devices 30 and 32, respectively, in the mixture forming zone and/or in the, or at, the reaction accelerator 26. The section marked d₂ indicates the axial dimension of the electric heating devices 32 at the reaction accelerator 26. It can extend either along the entire length 12 of the reaction accelerator 26 or, as illustrated in FIG. 5, only along a partial area of the latter. The area of the reaction accelerator of the length d₂ to be electrically heated does not necessarily have to be situated at the reaction accelerator inlet but may also start inside the reaction accelerator 26 at a certain distance from the reaction accelerator inlet. A reaction accelerator area 26a, which is not electrically heatable, as required, may also be constructed of an electrically non-conductive material, such as a ceramic material. A corresponding situation applies to the heating of the mixture forming zone 14. Here also, either the entire axial dimension l₁ of this zone can be electrically heated or the heating may take place only in an area d₁<l₁ within this zone at a certain distance from the start of the mixture forming zone 14.

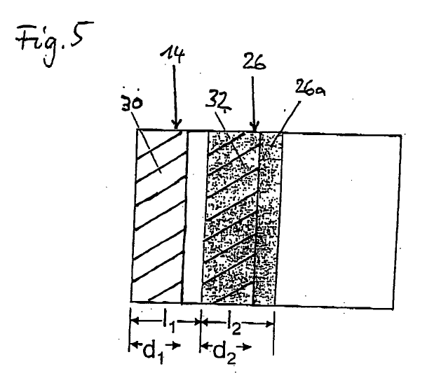

FIG. 4 shows another embodiment of a reformer which may optionally be used in a reformer system according to the invention illustrated in FIGS. 1 to 3. In the case of this reformer 10, the air 24 is not caused to flow by way of the in-flow zone 12 at the forward side of the reformer 10, as illustrated in FIGS. 1, 2 and 3, into the mixture forming zone 14, but rather is laterally introduced into the mixture forming zone 14 by way of a heat exchanger zone 44 enveloping the reformer 10. The heat exchanger zone 44 is connected in a heat-conducting manner with the reaction zone 16, as well as the out-flow zone 18. As a result, in the normal operation of the reformer system, after the starting phase, the in-flowing air 24 is preheated even before entering into the mixture forming zone 14.

Table of Reference Symbols

| | |
|---|---|
| 10 | reformer |
| 12 | in-flow zone |
| 14 | mixture forming zone |
| 16 | reaction zone |
| 18 | out-flow zone |
| 20 | injector |
| 22 | fuel |
| 24 | air |
| 26 | reaction accelerator |
| 26a | non-heated area of the reaction accelerator |
| 27 | face of the reaction accelerator |
| 28 | reformate gas |
| 30 | electric heating devices of the mixture forming zone |
| 32 | electric heating devices of the reaction accelerator |
| 34 | electric circuit |
| 34a | electric circuit |
| 36 | high-performance capacitor |
| 38 | electric circuit |
| 40 | vehicle battery |
| 42 | electric ignition device |
| 44 | heat exchanger zone |
| d₁ | heating section of the mixture forming zone |
| d₂ | heating section of the reaction accelerator |
| l₁ | entire length of the mixture forming zone |
| l₂ | entire length of the reaction accelerator |

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A reformer system, comprising:
a reformer for chemically converting a hydrocarbon-containing fuel to a hydrogen-gas-rich reformate gas;
electric heating devices by which thermal energy for generating a reaction temperature required for the conversion is fed to the reformer; and
a capacitor which supplies the electric heating devices with electric current.

2. The reformer system according to claim 1, wherein the capacitor is a high-performance capacitor.

3. The reformer system according to claim 1, wherein the reformer includes a chemical reaction accelerator for reducing a reaction temperature required for the conversion, and wherein the reaction accelerator is heatable at least in a heating section by way of the electric heating devices.

4. The reformer system according to claim 3, wherein the electric heating devices are integrally connected with the reaction accelerator.

5. The reformer according to claim 4, wherein the electric heating devices form a substrate of the reaction accelerator in the heating section.

6. The reformer system according to claim 3, wherein an electrically insulating material forms a substrate of the reaction accelerator outside the heating section.

7. The reformer system according to claim 5, wherein an electrically insulating material forms a substrate of the reaction accelerator outside the heating section.

8. The reformer system according to claim 7, wherein the electrically insulating material is a ceramic.

9. The reformer system according to claim 1, wherein the reformer includes a processing zone for processing the hydrocarbon-containing fuel before the chemical conversion, and wherein the processing zone is heatable by way of the electric heating devices.

10. The reformer system according to claim 9, wherein the processing zone is constructed as at least one of a mixture forming zone in which the hydrocarbon-containing fuel is mixed with air, and a fuel vaporization zone in which the hydrocarbon-containing fuel is vaporized.

11. The reformer system according to claim 1, wherein the electric heating devices comprise at least one of: a wire grid, devices for generating electromagnetic radiation, and devices for generating an arc or a plasma.

12. The reformer system according to claim 9, wherein the reformer has a heat exchanger zone which is connected in a heat-conducting manner with at least one of an out-flow zone of the reformate gas and a reaction zone having the reaction accelerator, by which outside air may be preheated and caused to flow into the processing zone.

13. The reformer system according to claim 9, further comprising an electric ignition device arranged in an area of the processing zone, by which a fuel combustion or fuel oxidation is generated for heating the processing zone.

14. The reformer system according to claim 1, wherein the hydrocarbon-containing fuel which is convertible by the reformer system is liquid and comprises at least one of gasoline, diesel, military fuels, kerosene biodiesel, alcohol, and oxygenated fuels.

15. The reformer system according to claim 1, wherein the reformer performs a partial oxidation process for converting the hydrocarbon-containing fuel to hydrogen-rich reformate gas.

16. The reformer system according to claim 1, further comprising:
a temperature sensor for measuring a temperature in at least one of a processing zone and at a reaction accelerator; and
a control unit for controlling a current supply of the electric heating devices as a function of the measured temperature.

17. The reformer system according to claim 1, further comprising a control unit for controlling a current supply of the electric heating devices in adaptation to marginal conditions of the reformer system.

18. The reformer system according to claim 17, wherein the marginal conditions include at least one of aging effects, component tolerances, and fuel influences.

19. A vehicle, comprising a reformer system, wherein the reformer system includes:
a reformer for chemically converting a hydrocarbon-containing fuel to a hydrogen-gas-rich reformate gas;
electric heating devices by which thermal energy for generating a reaction temperature required for the conversion is fed to the reformer; and
a capacitor which supplies the electric heating devices with electric current.

20. The vehicle according to claim 19, further comprising:
a consuming device; and
an exhaust gas aftertreatment system of an internal-combustion engine and/or a fuel cell, which aftertreatment system is coupled with gas feeding devices for feeding a reformate gas from the reformer system to the consuming device.
